(19) United States
(12) Patent Application Publication
(10) Pub. No.: US 2011/0049766 A1
(43) Pub. Date: Mar. 3, 2011

(54) METHODS OF FORMING GRAPHICS ON A SUBSTRATE AND LASER ACTIVE COATINGS

(76) Inventors: Bonifacio M. Del Mundo, South Elgin, IL (US); James Pfau, Kirkland, IL (US); Henry Coghlan, Elburn, IL (US)

(21) Appl. No.: 12/862,890

(22) Filed: Aug. 25, 2010

Related U.S. Application Data
(60) Provisional application No. 61/236,702, filed on Aug. 25, 2009.

(51) Int. Cl. B29C 35/08; C08K 3/22

(52) U.S. Cl. 264/400; 524/1

(57) ABSTRACT

Methods, articles, and systems for forming a graphic on a substrate and laser-active coatings are provided. One method comprises applying a laser beam to a laser-active coating on a surface of an article to mark a graphic in the laser-active coating, the laser active coating comprising a polymer binder and a pigment.

### CROSS-REFERENCE TO RELATED APPLICATIONS AND CLAIM TO PRIORITY

This patent application claims the benefit of U.S. Provisional Application No. 61/236,702, entitled “Methods of Forming Graphics on a Substrate and Laser Active Coatings,” and filed Aug. 25, 2009, the entirety of which is incorporated herein by reference and to which priority is claimed.

### FIELD OF THE INVENTION

The present disclosure generally relates to methods of laser forming graphics on coatings, to laser-active coatings, to articles made according to such methods and/or including the laser-active coatings, and to apparatus for making and marking laser-active coatings and articles.

### BACKGROUND OF THE INVENTION

In some applications, consumers desire articles that appear to be made of a natural material, such as wood. Wood materials are particularly in demand for building products such as doors, molding, millwork, furniture, paneling, decorative trim, chair rails, and siding. Unfortunately, natural materials such as wood may be quite expensive to harvest and manufacture.

Synthetic materials are often less costly than natural materials such as wood, and can provide other advantages over natural materials, including lighter density, greater durability, and ease of manufacture. On the other hand, synthetic materials can fail to provide a close resemblance to natural products. To provide these synthetic materials with the appearance of natural material such as wood, it is known to apply veneers and ink to the exterior surface of synthetic articles to simulate the appearance of natural wood. Alternative decorative artistic designs, patterns, non-decorative designs, logos, and other visual compositions may be formed on articles to give them other unique and attractive appearances.

Many graphics, including wood-grain patterns, comprise complex and intricate designs that can be difficult to form. Previously, methods such as ink jet printing, embossing, chemical etching, sandblasting, and screen printing have been used to form graphics on the exterior surfaces of various types of substrates. However, these known methods are often costly, complicated, and time consuming, and frequently do not produce a satisfactory result. Many methods simply lack the precision to ensure that fine details of the graphics are accurately and repeatably produced. Additionally, in the case of simulating natural wood, many methods do not provide both the appearance and texture of authentic wood. For example, natural wood tends to be textured to the touch and have a non-uniform color. Depending on the species of wood, the natural wood may include streaks of color or discolorations on the surface. However, previous efforts at producing wood-grain patterns on man-made materials have produced graphics that are very uniform in color and/or do not have the color and feel of natural wood.

### SUMMARY OF THE INVENTION

Embodiments of the invention provide methods of forming graphics on a substrate and laser active coatings. In accordance with one aspect of the invention, a method of forming a graphic on a substrate comprises applying a laser beam to a laser-active coating on a surface of an article to mark a graphic in the laser-active coating. The laser-active coating formulation comprises a polymer binder and a pigment, and optionally may contain additional ingredients.

In accordance with another aspect, a laser-active coating formulation for forming graphics on substrates is provided. The formulation contains at least a polymer binder having a glass transition temperature which provides a desired effect upon activation of the formulation by a laser beam, and a pigment having a heat resistance and present in a concentration which provide a desired effect upon activation of the formulation by the laser beam.

Other aspects of the invention, including apparatus, systems, methods, and the like which constitute part of the invention, will become more apparent upon reading the following detailed description of the exemplary embodiments and viewing the drawings.

### BRIEF DESCRIPTION OF THE DRAWINGS

The accompanying drawings are incorporated in and constitute a part of the specification. The drawings, together with the general description given above and the detailed description of the exemplary embodiments and methods given below, serve to explain the principles of the invention. In such drawings:

FIG. 1 is a flow chart of a method according to an embodiment of the invention;

FIG. 1a is a modified flow chart of a method according to an embodiment of the invention;

FIG. 2 is a plan view of a laser-marked grain wood pattern according to an embodiment of the invention;

FIG. 2a is a perspective view of a door having a door skin with a laser-marked grain wood pattern according to an embodiment of the invention;

FIG. 3 is a schematic diagram of a system for forming graphics on a substrate with a laser active coating according to an embodiment of the invention;

FIG. 4 is a schematic diagram of a coating device for forming graphics on a substrate with a laser active coating according to an embodiment of the invention;

FIG. 5 is a schematic diagram of a laser system for forming graphics on a substrate with a laser active coating according to an embodiment of the invention;

FIG. 6 is an illustration of a laser-marked substrate according to an embodiment of the invention; and

FIG. 7 is an illustration of a laser-marked substrate according to another embodiment of the invention.

### DETAILED DESCRIPTION OF THE PREFERRED EMBODIMENTS

Reference will now be made in detail to exemplary embodiments and methods of the invention as illustrated in the accompanying drawings, in which like reference characters designate like or corresponding parts throughout the drawings. It should be noted, however, that the invention in its broader aspects is not limited to the specific details, representative apparatus, compositions, methods, and illustrative examples shown and described in connection with the exemplary embodiments and methods.

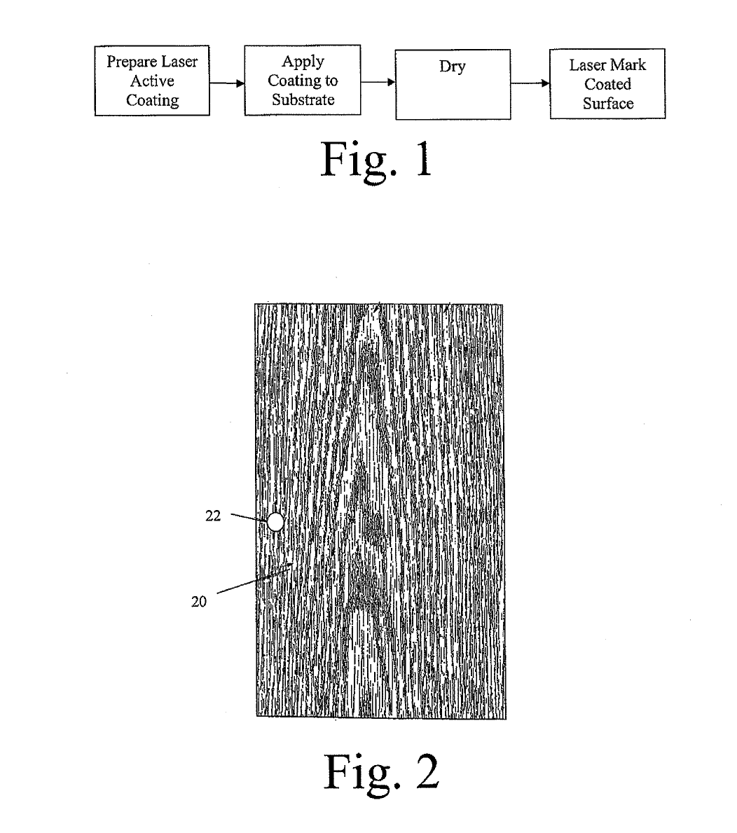

In accordance with an embodiment of the present invention generally shown in FIG. 1, a method is provided in which a water-based coating formulation is prepared, applied to a surface of a substrate, and dried to provide a laser-active coating, which is marked with a laser to form a graphic design in the laser-active coating.

The nature of the substrate is not particularly limited. The substrate should be adequate to support the coating formulation and permit its successful lasing. The substrate may be a “permanent” substrate on which the coating is both formed and lased. Alternatively, the substrate may be a “temporary” substrate on which the coating is formed, but which is separated from the coating prior or subsequent to lasing. Representative classes and examples of substrates that may be utilized include, but are not necessarily limited to, plastics, acrylics, vinyls, melamine, polyethylene terephthalate (e.g., Mylar®), polycarbonates (e.g. Lexan®), metals, steel, glass, fiberglass, ceramics, textiles, leather, marble, composites, paper, rubber, foam, stone, silicon, veneer, laminates, tile, cork, fiberglass and wood composites such as medium density fiberboard, hardboard or the like.

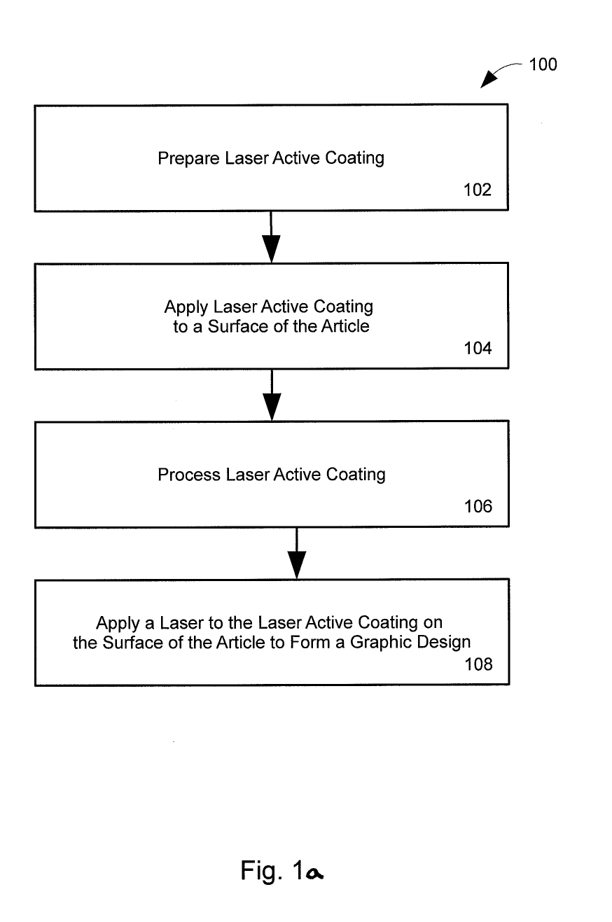

Articles that may be prepared or subject to marking according to exemplary embodiments of the present invention include for example synthetic building components intended to replicate natural wood. Especially contemplated are exterior entry doors and interior passage doors, decks, siding, paneling, furniture components, etc., whether of solid construction or so-called hollow core doors constructed from a door frame with door skins respectively mounted on opposite sides of the door frame. Peripheral door frames include stiles and rails which define the sides and top and bottom of the door. First and second door skins have interior surfaces respectively secured to opposite sides of the peripheral door frame via bonding, mechanical fasteners, etc. The exterior surfaces of the first and second door skins face away from one another, and are generally visible in use. FIG. 2 shows the exterior surface of a flush door skin 20 mounted to a frame (not shown). The door skin 20 has a wood grain pattern laser marked in its exterior surface. Although not shown, the laser may be used to mark other graphics into the exterior surface, such as interior panel members. Also not shown, the grain patterns may run either vertically or horizontally at different areas of the door facing to provide the appearance of stiles and rails, respectively. As known in the art, hollow core doors may include additional support members and/or core materials (e.g., foam) disposed between the skins. Hardware such as doorknob 22 may be installed.

Other building components that may be subject to the exemplary methods and systems described herein include furniture and cabinet doors, closet and bifold doors, door trim, window frames, furniture elements, cabinetry, picture frames, tables, molded wall paneling, wainscot, decking, wall panels, siding, railings, window trim, architectural trim, flooring, etc. For explanatory purposes, exemplary embodiments below are described in relation to building components, in particular hollow core doors. It should be understood that the methods and systems described herein may be used for marking other building components and articles other than building components.

In accordance with one embodiment of the present invention, FIG. 1a is a modified flow chart of a method 100 for forming graphics on a substrate having a laser-active coating applied thereon. In the method 100, a laser-active coating is prepared in step 102 and applied to a surface of an article in step 104. The laser-active coating can be optionally processed in step 106 (e.g. dried) before a laser beam is applied to the laser-active coating on the surface of the article to form a graphic design in step 108.

As used herein, the terms “graphic” and “graphic design” are used interchangeably, and as used herein, refer to decorative and artistic designs, non-decorative designs, patterns, graphic images, natural patterns such as wood grain, other naturally occurring patterns, alpha-numeric characters, corporate and trade logos, or other markings, etc. The term “pattern” does not necessarily mean a repeating pattern as used herein.

The nature of the substrate is not particularly limited. The substrate should be adequate to support the coating formulation and permit its successful lasing. The substrate may be a “permanent” substrate on which the coating is both formed and lased. Alternatively, the substrate may be a “temporary” substrate on which the coating is formed, but which is separated from the coating before or after lasing. As previously mentioned, representative classes and examples of substrates that may be utilized include, but are not necessarily limited to, plastics, acrylics, vinyls, melamine, polyethylene terephthalate (e.g., Mylar®), polycarbonates (e.g. Lexan®), metals, steel, glass, fiberglass, ceramics, textiles, leather, marble, composites, paper, rubber, foam, stone, silicon, veneer, laminates, tile, cork, and wood composites, such as medium density fiberboard, hardboard and the like.

Articles that may be prepared or subject to marking according to exemplary embodiments of the present invention include synthetic building components intended to replicate natural wood. Especially contemplated are exterior entry doors and interior passage doors, decking, siding, paneling, furniture components, etc., whether of solid construction or so-called hollow core doors constructed from a door frame with door skins respectively mounted on opposite sides of the door frame.

Other building components that may be subject to the exemplary methods and systems described herein include furniture and cabinet doors, closet and bifold doors, door trim, window frames, furniture elements, cabinetry, picture frames, tables, molded wall paneling, wainscot, decking, wall panels, siding, railings, window trim, architectural trim, flooring, etc. For explanatory purposes, exemplary embodiments below are described in relation to building components, in particular hollow core doors. It should be understood that the methods and systems described herein may be used for marking other building components and articles other than building components.

FIG. 2a is a perspective view of a door having a door skin 110 attached to a peripheral door frame 112. The door skin 110 comprises vertical stiles 114a, 114b and horizontal rails 116a, 116b, 116c, 116d, 116e which define the sides and top and bottom of the door, as well as interior panels 118a, 118b, 118c, 118d. The door skin 110 has an interior surface secured to the peripheral door frame 112 via bonding, mechanical fasteners, etc. A second door skin (not shown in FIG. 2a) can be secured to the opposite side of the door frame 112. The exterior surfaces of the first and second door skins face away from one another, and are generally visible in use. As known in the art, hollow core doors may include additional support members and/or core materials (e.g., foam) disposed between the skins. Hardware such as doorknob 22 may be installed. The door skin 110 may be made from medium density fiberboard, hardboard, fiberglass, steel, or laminate materials used to finish door skins.

The door skin 110 has a wood grain pattern laser marked in to its exterior surface. As shown in FIG. 2a, articles can be produced with a graphical wood grain running in various directions, as illustrated with a vertically oriented grain pattern on the stiles 114a, 114b, which is oriented perpendicular to a horizontally oriented grain pattern of the rails 116a, 116b, 116c, 116d, 116e. A laser beam can also mark other graphics or visible features into the surface of the article, such as interior panels 118a, 118b, 118c, and 118d. Features such as the interior panels 118a, 118b, 118c, and 118d may be created flush with the rest of the graphics, or alternatively laser-etched to a different depth than other graphics on the article. The door skin 110 maybe a flush or flat door skin, or conversely a molded door skin with added depth.

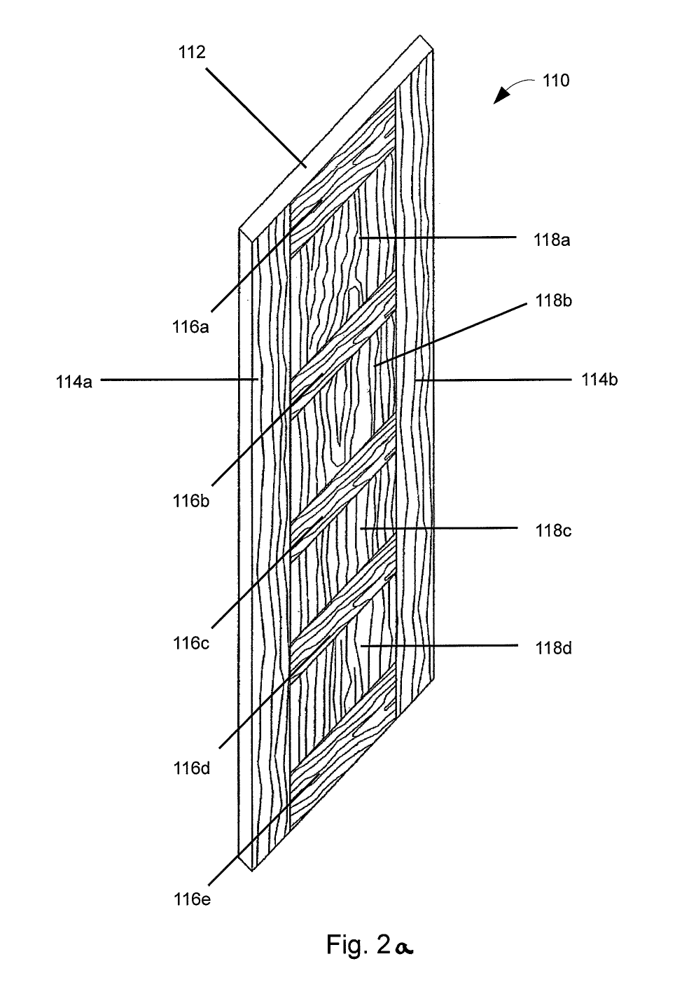

FIG. 3 is a schematic view of a system 120 for forming graphics on a substrate with a laser-active coating. The system 120 comprises a controller 122 in communication with a coating device 124, a coating processor 126, and a laser 128. Articles 110a, 110b are positioned on a work bed 130, which may be a conveyor belt which moves articles from one station to the next. The articles 110a, 110b are moved on the work bed 130 in the direction of arrow 132, roughly from left to right.

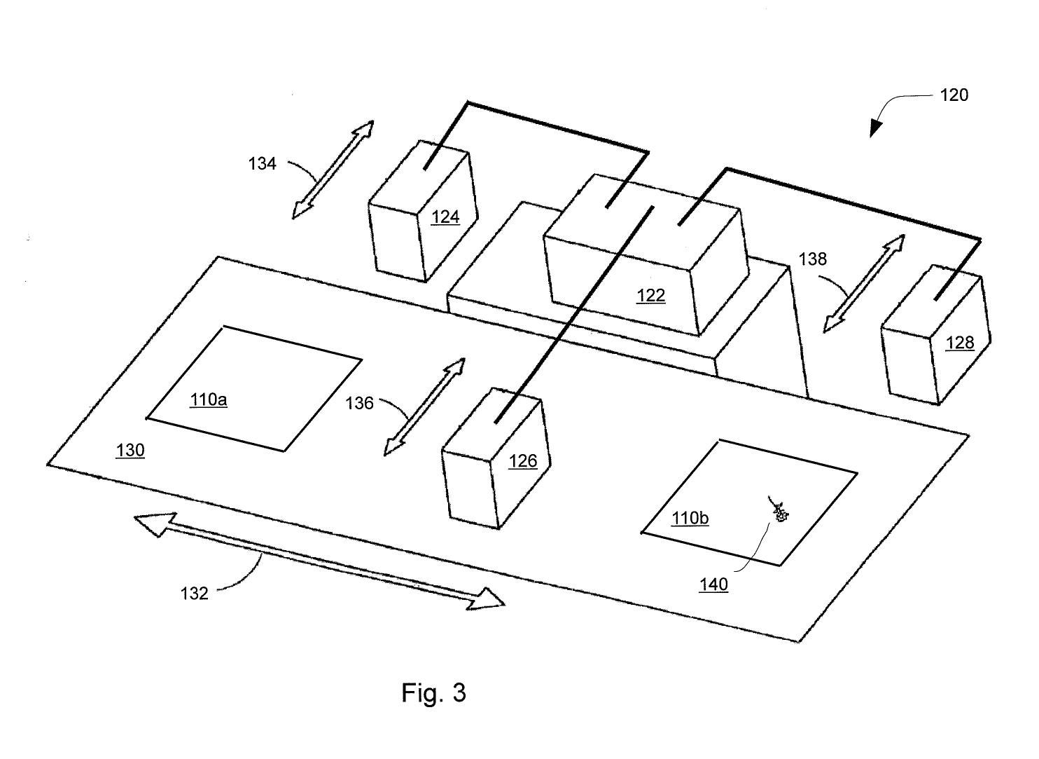

During a first stage, the coating device 124 prepares and applies a laser-active coating formulation to the surface of an article 110a. FIG. 4 is a schematic diagram of a coating device 124 for forming graphics on a substrate of article 110 with a laser active coating according to an embodiment of the invention. The coating device 124 may comprise a coating sprayer, configured to apply (e.g. spray) the laser-active coating onto a substrate of the article 110. The coating device 124 may move across the width of the article 110, as shown by the direction of arrow 134 in FIG. 3. Alternatively, the laser-active coating formulation may be prepared on the surface of the substrate on which lasing will occur. In certain exemplary embodiments of the invention, the coating will have a relatively small thickness on the order of a paint coating or coatings. For example, the thickness of the dried coating may be in a range of about 0.5 mils (about 0.0127 mm) to about 6.0 mils (about 0.1524 mm). Accordingly, the coatings of certain embodiments of the invention are also referred to herein as paints and paint coatings. It should be understood, however, that the coating formulation may be applied in a variety of thicknesses depending on the particular application.

After the laser-active coating is applied to or formed on the substrate of the article 110, the laser-active coating may optionally undergo further processing. For example, the laser-active coating may be dried by a coating processor 126, such as a heat lamp or drier. The coating processor may travel across the surface of the article in the direction of arrow 136. Alternatively, coating processor 126 may comprise an oven, through which the article 110 progresses to assure drying of the laser-active coating.

At the third stage, after the laser-active coating has been applied to (or formed) on the substrate, and optionally processed, the laser-active coating is ready to be activated by a laser beam generated by the laser 128. By “laser active,” it is meant that the coating, in response to treatment by a laser, is capable of undergoing a change of appearance that is visibly perceivable to the naked eye. Laser-activation may occur due to absorption of laser energy by the coating, causing a physical and/or chemical change to the coating. For example, the activated area of the coating (along which the laser has traversed) may ablate, sublimate, melt and flow, and/or change color. The physical and/or chemical changes may be controlled by controlling the amount of energy applied to and ultimately absorbed by the coating. This may be accomplished by varying the length of exposure time, changing the power setting of the laser, and/or varying the concentration of the heat sensitive pigment in the formulation.

The controller 122 will typically guide the laser 128 along a predetermined path across the surface of the article coated with the laser-active coating. The path may be predetermined to correspond to a desired graphic or the path may be random. Manipulation of the laser may be performed manually or automatically, e.g., mechanically. A multitude of graphics may be marked in the coating in this manner.

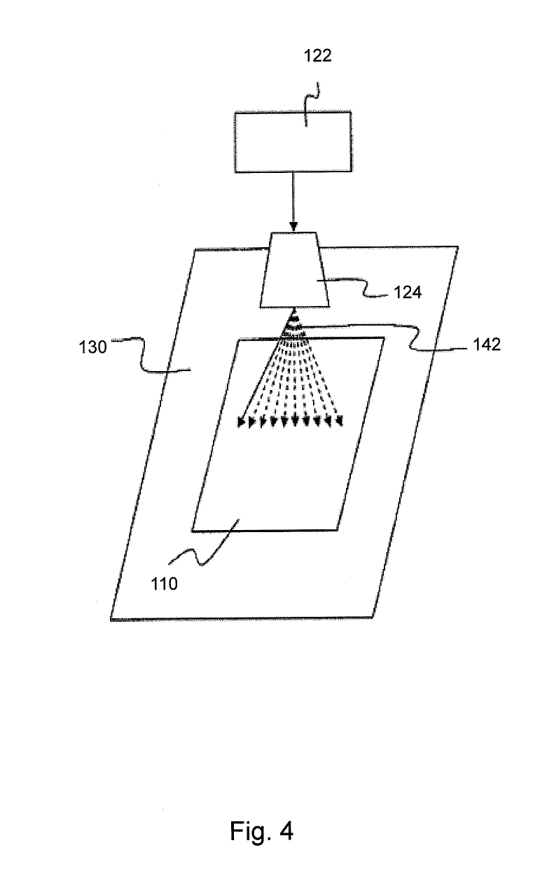

FIG. 5 illustrates a system 200 comprising a laser 128 for forming graphics on a substrate 142. The laser 128 generates a laser beam 206 to activate at least part of the laser-active coating on the article 110. The laser beam 206 is generated in a direction of a mirror system manipulated by controller 122. The illustrated mirror system includes an x-axis mirror 218 rotatably mounted on and driven by an x-axis galvanometer 210. The x-axis galvanometer 210 is adapted to rotate in the direction of 214 and cause the rotation of the x-axis mirror 218. Rotation of the x-axis mirror 218 while the laser beam 206 is incident on the mirror 218 causes the laser beam 206 to move along the x-axis of the article 110.

The controller 122 controls the output of a power source (not shown in FIG. 5) to control the x-axis galvanometer's 210 rotation of the x-axis mirror 218. The laser beam 206 is deflected by the x-axis mirror 218 and directed toward a y-axis mirror 220 rotatably mounted on y-axis galvanometer 212. The y-axis galvanometer 212 is adapted to rotate and cause rotation of the y-axis mirror 220 in the direction of arrow 216. Rotation of the y-axis mirror 220 causes movement of the laser beam 206 incident on mirror 220 along the y-axis of the article 110. The controller 122 controls the output of the power source (not shown in FIG. 5) delivered to y-axis galvanometer 212 for controlling rotation of the y-axis galvanometer 212 and mirror 220.

The laser beam 206 is deflected by the y-axis mirror 220 and directed through a focusing lens 222 adapted to focus the laser beam 206. The lens 222 may be a multi-element flat-field focusing lens assembly, which optically maintains the focused spot on a flat plane as the focused laser beam 224 moves across the article 110 to scribe or mark a graphic 140. The lens 222, mirrors 218, 220 and galvanometers 210, 212 can be housed in a galvanometer block (not shown).

The system 200 further includes a working surface 130 which can be a solid substrate such as a table, conveyor belt, or even a fluidized bed. A work piece article (e.g., door skin) 110 is placed on the working surface 130. The article 110 includes a viewable, laser-markable substrate 142 to be laser marked. The working surface 130 can be adjusted vertically to adjust the distance from the lens 222 to the laser-markable substrate 142 of the article 110. The laser beam 206 is directed by the mirrors 218, 220 against the laser-markable substrate 142 of the article 110. Usually the focused laser beam 224 is directed generally perpendicular to the laser-markable substrate 142, but different graphics can be achieved by adjusting the angle between the laser beam 224 and the laser-markable substrate 142, for example, from about 45° to about 135°.

Relative movement between the laser beam 224 in contact with the laser-activated coating on the substrate 142 of the article 110 causes a graphic 140, such as a flower, to be lazed on the substrate 142. The movements and timing of the mirrors 218, 220 and the power of the laser beam 206 are controlled by the controller 122 to laser mark the specific desired graphic 140. As referred to herein, relative movement may involve movement of the laser beam 224 (e.g., using the mirror system) as the article 110 remains stationary, movement of the article 110 while the laser beam 224 remains stationary, or a combination of simultaneous movement of the laser beam 224 and the article 110 in different directions and/or at different speeds.

The controller 122 can control the galvanometers 210, 212 (and thus mirrors 218, 220) and the power output of the laser beam 206 to form the graphic 140 on the substrate 142 of the article 110 at the appropriate power and movement velocity for high throughput. The power and speeds should be controlled to avoid any undesirably consequences of over-treatment, such as complete carbonization, burn-through and/or melting of the article 110. The energy density per unit time of the focused laser beam 224 applied to the substrate 142 should be controlled, as explained in U.S. Pat. No. 5,990,444 to Costin, the disclosure of which is herein incorporated by reference.

The controller 122 can be a personal computer system. Computer hardware and software for carrying out the embodiments of the invention described herein may be any kind, e.g., either general purpose, or some specific purpose such as a workstation. The computer may be a Dual Core or Pentium® class computer, running Windows XP®, Windows Vista®, or Linux®, or may be a Macintosh® computer. The computer may also be a handheld computer, such as a PDA, cell phone, or laptop. The programs may be written in C, or Java, Brew or any other programming language. The programs may be resident on a storage medium, e.g., magnetic or optical, of, e.g., the computer hard drive, a removable disk or media such as a memory stick, or SD media, flash drive, or other removable medium. The programs may also be run over a network, for example, with a server or other machine sending signals to one or more local machines, which allows the local machine(s) to carry out the operations described herein.

It should be understood that other embodiments of the invention may be carried out using various other laser systems having alternative layouts and components to those shown in FIGS. 3-5. For example, the laser beam 206 can first pass through the focusing lens 222 and then be directed to the scan mirrors 218,220 in a typical post objective scanning architecture. A variety of lasers 128 may be used to activate the laser-active coating to form the graphic. The laser 128 may be a pulsed laser or continuous wave laser. As one example, the laser 128 comprises a continuous wave CO₂ laser operating in the wavelength range of about 9.0 to about 10.6 microns. The power and speed of laser movement may be controlled to effect the desired change while avoiding undesirable consequences of over-treatment. In some embodiments, for example, complete carbonization, burn-through and/or melting of the marked material may be unwanted. Slower movements and higher powers will typically lead to greater absorption by the coating, while faster movements and lower powers will typically result in lower absorption levels. The depth over which the laser energy is absorbed by the coating depends on the laser wavelength, as well as other factors such as the optical properties of the coating, discussed below. Examples of lasers and laser guidance systems suitable for many of the exemplary embodiments described herein can be found in U.S. Patent Application Publication No. 2007/0108170 to Costin et al. and WO2008/156620 to Costin et al, both herein incorporated by reference.

For a pulsed laser, the laser speed may range from about 20 meters per second to about 50 meters per second. Typically the laser speed can vary depending upon various factors, such as the desired degree of absorption by the coating, which may differ from one area to another area. Laser speed refers to the speed a lazed line can be created without any power limitations at a defined distance from the laser optics. The energy of the pulsed laser maybe controlled by varying the setting of electrical power supplied to the laser unit. For example, in the case of a 2500 watt capacity laser, the setting may be, for example, from 30 to 100% power, depending upon the power capacity of the laser unit. Generally, lasers 128 have power output from 500 to 2500 watts or more.

The laser beam may be directed along any path to form a graphic 140 on the coated substrate. The path of the laser beam may comprise virtually any pattern, design, logo, product information, or other representation which is desired to be formed on a substrate 110. In other embodiments, the laser beam may contact the coated substrate along a path which forms words, scenes, and/or abstract decorative and/or functional designs. As one example of a lased graphic, the laser beam may contact the coated substrate along a path which simulates a wood-grain pattern, as illustrated in FIG. 2a. In some embodiments, a simulated wood-grain pattern may comprise a series of relatively short discrete segments, spaced very closely together to produce the appearance and feel of real wood grain. Such wood grain patterns may be created by scanning photographs of authentic wood using an optical scanner or optical reader. The scanned file can be manually touched-up by the operator or automatically via a software program of a work station computer, and used to guide the laser beam.

A variety of visual effects can be produced by manipulating various factors of the graphics-forming process. For instance, laser-active coating formulations may be prepared having specific properties and the activation of the coating formulation may be controlled in order to produce a variety of effects. In certain embodiments, articles may be produced with a graphic of a first color and a surrounding surface area of a different second color. For example, the graphic may be the color of the substrate and the surrounding area may be the color of the coating formulation. The matching of graphic and surrounding area colors may be accomplished by incorporating into the composition one or more heat-sensitive pigments that change color upon laser treatment to provide a color that is similar or identical to the color of the substrate. Alternatively, the graphic may be a color different from the substrate, for example, a color of a second coating formulation or another color. In some embodiments, man-made substrates such as engineered woods may be produced having a graphic comprising a wood-grain pattern and the differing colors of the wood grain graphic and surrounding area may give the appearance of real oak, cherry, walnut, mahogany, or other wood. Alternatively, the differing colors of the wood-grain graphic and the surrounding area may produce a multitude of other effects.

In some embodiments, more than one coating formulation may be applied to a substrate, with one or more of the coating formulations subsequently activated, while one or more other coating formulations are left un-activated. The activation of some coating formulations may remove those layers of coating along the laser path, e.g., by evaporation, sublimation, or melting, and expose a non-activated formulation below.

According to certain exemplary embodiments of the invention, the laser-active coating formulation comprises a base polymer and a pigment. The coating formulation may optionally comprise other additives such as pigment extenders and fillers. The pigment may be inorganic and/or organic, although inorganic pigments are often preferred. Preferably the additives are non-hazardous, as is the coating formulation as a whole. It is also preferable that the coating formulation be water based. Acrylic polymer emulsions are particularly useful, as described below. The appearance (e.g., color) of the active area of the coating may be adjusted and controlled by selection of the resin, pigment and/or additives of the laser active coating formulation.

The laser-active coating formulation may include varying amounts of a polymer binder (e.g. resin). It should be understood that the concentration of resin will affect coating adhesion, responsiveness to laser activity, and other performance and appearance properties. Generally, a laser-active coating may contain a resin concentration of about 30 to about 45 percent (dry weight), although the resin concentration may depart from this range depending upon the intended application of the coating.

A variety of resins may be selected for the laser coating formulation. The particular selection of resin or resins may be based on a variety of factors discussed below. In certain exemplary embodiments, the resin includes an acrylic emulsion resin such as polymethyl methacrylate (PMMA), polymethyl acrylate (PMA), polybutyl acrylate (PBA), polystyrene acrylic copolymers, polyvinyl acrylate (PVA), polyhydroxyethyl acrylate (PHEA), and/or mixtures thereof. Other suitable resins may include polyvinyl acetate (PVAc), polyurethanes, epoxies, cellulosic resins, styrene and styrene modified copolymers, and alkyd resins.

One factor which may be taken into consideration in selecting a resin is its glass transition temperature (T_{g}). The glass transition temperature (T_{g}) of a resin may influence the width and/or distinctness, (details, sharpness, and clarity of the image) of the region activated by the laser. For example, in some applications the desired graphic may include fine lines and/or intricate details, such as those that might be produced by a fine point pen. In other applications, it may be desirable to produce less distinct, thicker, slightly blurred or hazy lines. Without wishing to be bound to any theory, it is nonetheless postulated that the selection of a resin having a particular T_{g} may affect the degree of melting and flowing of the coating, which in turn affects the width and/or distinctness of the region activated by the laser and thereby marked.

While resins having a T_{g} within a wide range may be utilized in the coating formulation, the particular choice may depend on the desired effect to be achieved by the activation of the formulation and the desired final appearance of the graphic. For example, in certain exemplary embodiments, resins having glass transition temperatures in a range of about 12° C. to about 53° C. may be utilized. The selection of a resin having a T_{g} near the upper end of the range may produce a wider, less distinct activated region along the path of the laser beam. In contrast, the selection of a resin having a T_{g} near the lower end of the range may produce a narrower activated region along the path of the laser beam. Other factors that will influence the width and depth of energy absorption by the activated coating area include the power and speed of the laser beam. Energy absorption may also be influenced by the optical density of the coating formulation. Coating formulations having higher optical densities tend to absorb more energy than formulations having lower optical densities.

It has been found that resins having lower glass transition temperatures absorb more energy and resins having higher Tg absorb less energy. It has been demonstrated that the Tg from 12° C. to 53° C., and possibly outside this range, affect the optical density. Thus, the optical density of a coating formulation may be affected by the selection of a resin having a particular Tg. A resin with a T_{g} well above ambient temperature is relatively stiff and brittle compared to a resin with a T_{g} well below the ambient temperature.

Various factors can cause the T_{g} of a resin to be high. As one example, rigid functional groups attached to the backbone polymer may cause the T_{g} of a resin to be high. The rigid structure prevents the backbone of the molecules from vibrating, rotating, or moving slowly and causes a physical change when exposed to light energy. High T_{g} can also be attributed to resins that are blends of soft and hard polymers wherein the hard polymer is present in greater proportion. For example, a resin with T_{g} of 12° C. is a soft acrylic copolymer, but when copolymerized with styrene, the T_{g} of the copolymer rises to 53° C. Styrene contains rigid aromatic rings that, when combined with other polymers, increases the T_{g}. Due to hardness, the high T_{g} resin tends to have high optical density and responds slowly to laser energy. The low T_{g} resin is soft and flexible, and the optical density is low and thus, responds to laser energy quickly.

In certain embodiments, a first coating area of a first coating formulation may be activated while a second coating area of a second coating formulation is not activated. For such embodiments, the first coating formulation may be prepared with a lower optical density than the second coating formulation. For example, the first coating formulation may be prepared with a resin having a lower Tg and the second coating formulation may be prepared with a resin having a higher Tg. Additionally, more than two coating formulations may be prepared using any combination of resins having high and low glass transition temperatures to affect the optical density and selective activation of different coating areas (depending upon the coating formulation) to produce a desired graphic.

The laser-active coating formulation further comprises one or more pigments, for example, one or more inorganic pigments. Examples of pigments that may be selected include iron oxides, titanium dioxide, chromium oxides, viridian pigments, cobalt compounds, cadmium compounds, magnesium ferrite, zinc iron chromite, manganese compounds, ultramarine, bismuth yellow, iron blue, cobalt yellow, tin oxide, antimony oxide, and/or mixtures thereof. Organic dyes may also be used in combination with or in lieu of inorganic pigments. A single pigment may be used, or alternatively, the coating formulation may include a combination of pigments. The particular selection of pigment(s) for use in the formulation may be based on any of a number of factors. For example, the pigment(s) may be chosen to impart a desired tint or color to the coating formulation. A multitude of pigments of differing colors are commercially available, and the selection of a particular pigment or combination of pigments to impart a desired tint or color is well within the ordinary skill of those in the art.

The selection of a particular pigment may be used to affect the activation of the formulation. For example, it may be desirable to select a heat-resistant pigment that does not absorb enough laser energy to cause a physical or chemical change of the pigment, resulting in an absence of color change. Conversely, a pigment that is not heat resistant may be selected for the formulation so that the pigment, and hence the coating, undergo a color change upon activation. The nature of the color change will depend upon the pigment selected. Thus, in some embodiments, the particular selection of pigment based on its heat resistance may be used to determine whether coating is laser-active. The color change may be, for example, from yellow to brown, yellow to red-orange, light brown to dark brown, light green to white, etc.

The pigment(s) may be present in the coating formulation in varying amounts. In certain embodiments, for example, the pigment concentration may be in a range of about 0.1 to about 20.0% percent (dry weight), although the amount of pigment may vary within and outside the range depending on the desired color and opaqueness of the coating. The particular concentration of pigment in the coating formulation may depend on any number of other factors as well. In some embodiments, the particular concentration is chosen to affect the activation of the laser-active coating. For example, it has been found that the pigment concentration may be chosen to affect the optical density of the formulation and thus the degree to which the coating formulation is activated. The higher the concentration of heat sensitive pigments, the higher is the degree of laser interaction. The coating formulation may be prepared with lower concentration of heat sensitive pigment (e.g., about 0.1 to about 5 weight percent) to yield a formulation having a lower optical density and thus affect a lower degree of interaction. For example, formulations which are intended to be removed, e.g., ablated, or undergo a color change upon activation may be prepared with a lower concentration of heat resistant pigment. In other embodiments, the coating formulation may be prepared with higher concentration of heat resistant pigment to yield a formulation having a higher optical density and thus affect a lower degree of activation. For example, formulations which are not intended to be removed or undergo a color change may be prepared with a higher concentration of heat resistant pigment or additives.

The laser-active coating formulation may also comprise a variety of additives, such as pigment extenders and/or fillers, to control the physical characteristics of the formulation. For example, fillers are used primarily to adjust rheological properties, modify gloss and drying properties, and occupy volume in the paint. Fillers may be present in an amount of, for example, about 10 to about 40 percent (dry weight) of the laser-active coating. Most fillers dissipate heat when in contact with the laser energy. For this reason, the amount may be selected to control the laser activity of the formulation. Representative fillers that may be used include kaolin, calcium carbonate, nepheline syenite, mica, talc, magnesium silicate, silicon dioxide, barium sulfates, etc.

Other additives that the coating composition may contain include wetting agents, dispersing agents, thixotropic agents, and others. Wetting and dispersing agents may be included in amounts of, for example, about 0.5 to about 5 percent (dry weight). Organo clays and organic thixotropes may be used to modify the viscosity of the paint and can extend the storage life. Organo clay, either hectorite or bentonite, may be used in amounts of about 0.1 to about 5 percent (dry weight) to provide viscosity build, sag control and pigment suspension. Organic thixotropes may be used in amounts of, for example, about 0.1 to about 2 percent (dry weight) to control flow characteristics of the coating. The thixotropes may be added while thinning down the paint when the paint is sheared upon mixing. Organic clays and thixotropes also provide anti-settling property for the pigments, and can control the flow of the coating, especially in the case of wet paint when the paint is applied on a surface.

Additives to control some surface defects may also be used. Such additives are typically classified by the defects they are designed to eliminate or suppress. Such additives may assist in the prevention or reduction of pinholes, fisheyes, crawling, edge crawling, and sagging after the paint has been applied. Surface-defect mitigating additives may constitute about 0.01 to about 2 percent (dry weight) of the formulation. Typically, increased amounts of such additives are more effective in preventing the defect from occurring.

Foam-control agents are additives that either destroy the existing foam (defoamers) in the paint or suppress the foam formation (antifoam) can also be included. Foam control agents may be added in an amount of, for example, about 0.01 to about 1 percent (dry weight).

The use of biocides entails the microbial protection of paint both in the can and the final paint film. Without biocides, the microbes can attack the cellulosic thickeners, pigment dispersants, glycols, and coalescing agents. The additives may lose strength and specific functions to sustain the life and performance of the paint as a result of microbial attack. Most biocides are normally insoluble and may require longer mixing times than other additives mentioned above. For this reason, biocides are usually combined with other additives before resin and pigments are added. Biocides may be present in the formulation in an amount of, for example, about 0.1 to about 2 percent by weight.

The resin, pigment, and optional additives, such as one or more of pigment extenders, fillers, and/or conventional paint additives, may be combined in any order using any conventional method. For example, the pigments and fillers may be ground in a high speed disperser together with other constituents such as water, pre-dispersed organo clays, anti-foam, wetting and dispersing additives. A Cowles single shaft high speed pigment disperser with variable speed from 100 to 6,000 rpm may be used. The dispersion blade may run at, for example, about 1,000 to about 4,000 rpm while inducing a shear force that is sufficient to cause the pigment particles to rub vigorously against one another and the container wall, or pass one another in close proximity. The agglomerates of pigment particles break down into fundamental size, that is, the smallest unit size of a pigment with a value that generally lies in a range of about 0.15 to about 0.25 microns, and consequently are mixed in the fluid portion until the mixture turns into a “grind paste”. The resin portion is added slowly into the grind paste while the dispersion blade is set at low speed, for example, about 200 to about 300 rpm. The slower blade rotation of this step is practiced to avoid significant shearing of resin particles.

Activation of the formulation may be controlled by diluting the formulation prior to applying it to the substrate. For example, the formulation may be diluted with water. It has been found that diluting the coating formulation may affect the optical density and thus alter the activation characteristics of the formulation. For example, in some embodiments the coating formulation may be diluted to reduce the optical density of the coating formulation and increase the amount of energy absorbed by the formulation. The coating formulation may be diluted in any suitable amount, for example, from 10% to 30% to increase the degree of activation and produce the desired graphic. Beyond 30% dilution, particular care should be taken, because there is a possibility for the polymer particles to condense in the solution or the pigment particles to settle and separate, and thus deteriorate the property of the paint. Water reduces the paint for thinner application. A thin dry film having, for example, an average thickness of 1 mil can be formed and ablated.

Additionally, activation of the formulation may be controlled by controlling the thickness of the coating that is applied to the substrate. The coating formulation may be applied in a variety of thicknesses depending on the particular application. For example, the thickness of the dried coating may be in a range of about 0.5 mils to about 6.0 mils. However, it has been found that controlling coating thickness may be used as a tool for reducing or preventing laser activation. Coatings having greater thicknesses may be more resistant or impervious to laser activation. In applications in which it is desirable not to remove or ablate a coating area, the coating applied that that area of the substrate may have a greater thickness than other areas of the substrate. Conversely, in applications where it is desired to remove, e.g., ablate, the coating formulation to produce the graphic, a thinner layer of the formulation may be applied in those areas in which the coating is to be removed or ablated. Typically, if complete ablation is desired, the coating will be provided with a thickness of about 0.6 to about 1.0 mil, while about 2.0 to about 6.0 mil coatings can be ablated to a selected depth by controlling the power of the laser.

The laser-active coating formulation may be applied to the surface of an article using any of numerous application methods. For example, the coating formulation may be sprayed, brushed, and/or rolled onto the substrate or the substrate may be dipped into the formulation. Depending upon the physical properties of the formulation, application may be performed with a spray gun. Conventional spray guns are well known. Spraying the coating formulation onto the substrate may allow for greater control over coating thickness. However, in applications where the thickness uniformity is more important, other methods may be employed to control laser activation and graphic formation.

Once applied, the coating formulation may be dried in any conventional manner. For example, the formulation may be allowed to dry in ambient conditions, or alternatively drying may be accelerated using an oven. In some embodiments, especially those employing water-based formulations, the coating formulation may be dried in a convection oven heated to a temperature of from about 110° F. (about 43° C.) to about 130° F. (about 54° C.) for about 5 to about 15 minutes.

A variety of effects may be achieved using the presently disclosed methods and laser-active coating formulations. By applying laser-active coating formulations having different properties to different areas of a substrate, activation may be controlled to create different effects (e.g., ablation, melting, color change), and a multitude of designs and results can be achieved. In embodiments in which multiple laser-active coating formulations are applied to different surface areas of the substrate, the formulations may differ in one or more properties to produce a desired effect. For example, the pigments of the different formulations may provide their respective coatings with different colors and different activation characteristics. Such surfaces areas also or alternatively may possess different pigment concentrations, resins, degrees of dilution, and fillers and additives to vary their colors and activation characteristics.

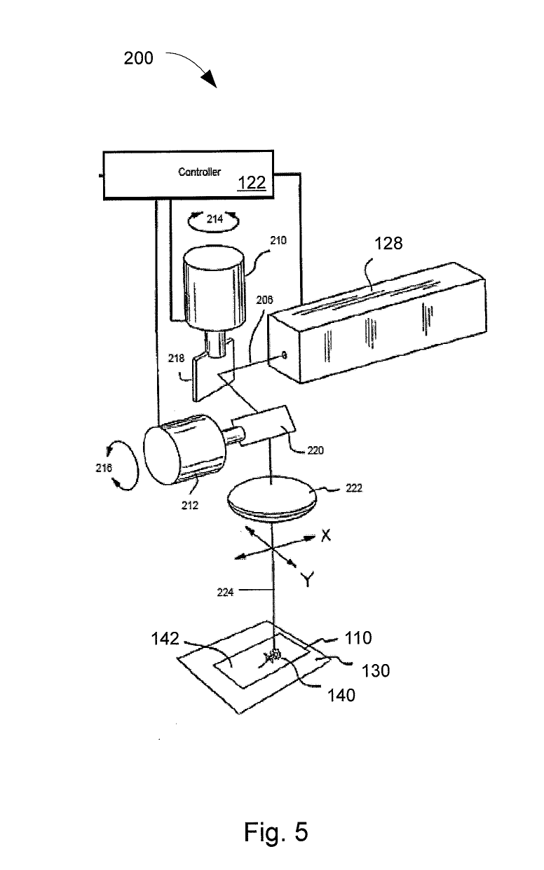

FIG. 6 illustrates a substrate 150 with a first layer of laser-active coating formulation 152 and a second layer of laser-active coating formulation 154 applied on top of the first layer 154. The second layer 154 comprises sections 156a, 156b, and 156c. During lazing section(s) 156b was ablated, as indicated by the dotted lines at the top of the section 156b. As shown by FIG. 6, ablation of the laser-active coating can create depth on an otherwise flat section of laser-active coating. Furthermore, ablation of the laser-active coating 154 at section 156b is complete, revealing a portion of the lower layer of laser-active coating 152. Sections 156a, 156c, however, were not ablated by the laser. The ablated portion(s) 156b causes the layer 154 to have a texture that can be felt and observed visually. Further, should the layer 152 be of a color different than the color of layer 154, then the resulting article will have visually different portions, allowing wood grain patterns and the like to be more realistic in appearance. Those skilled in the art will appreciate that there will be multiple ablated portions 156b, and that the portions 156b need not be uniform in width, length or depth. Further, the portions 156b need not be parallel. Thus realistic wood grain patterns, such as in FIG. 1, such as oak, cherry or the like, may be accurately simulated and have a realistic texture and coloration.

While several embodiments discussed above involve the use of multiple laser-activate coating formulations on different surface areas of a substrate, it should be understood that a single laser-active coating formulation may be applied to the substrate surface. In these embodiments the laser beam may or may not affect a change in the substrate. For example, the laser beam may mark the substrate along the laser path or alternatively, the laser beam may leave the substrate relatively unchanged. In certain implementations of the invention involving high power lasers, it may be difficult or unavoidable to leave the substrate beneath the coating unetched. In other embodiments, the activation may change the color or otherwise change the appearance of the coating along the laser path, but leave the non-activated coating its original color/appearance.

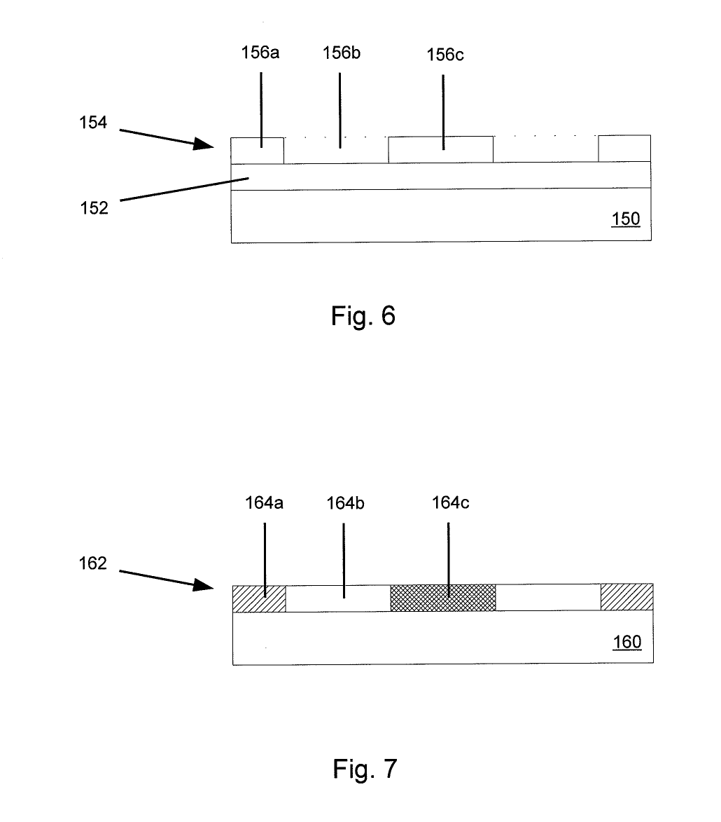

FIG. 7 illustrates a substrate 160 with a single layer of laser-active coating 162 applied to the substrate 160. The single layer of laser-active coating 162 comprises various sections 164a, 164b, and 164c. Colored sections 164a, 164c of the laser-active coating layer have been activated to show different colors, as represented by the diagonal hatching of section 164a and the cross-hatching of section 164c. Uncolored section 164b of the laser-active coating layer has not been activated—for example, the laser beam did not contact the surface of section 164b.

In other embodiments, a first (lower) laser-active coating of a first formulation may be applied to the surface of the substrate and a second (upper) laser active coating of a second formulation may be applied on top of the first coating. Upon activation, the second coating may be ablated along the path of the laser beam, exposing the first coating, but the properties of the first formulation may resist a visible change in appearance. Thus, the resulting graphic may have the appearance of the first (lower) coating which is revealed by removal of its overlying second (upper) coating in the lazed area(s). The surrounding, non-lazed areas may have the appearance of the second formulation. For example, if the first coating is dark brown in color and the second coating is light brown in color, and the laser activates the second coating along a path comprising a wood grain pattern, a substrate having the appearance of real oak may be produced. In other embodiments, activation may ablate the second coating and produce a color change in the first coating.

In still further embodiments, a first laser-active coating formulation may be applied to first regions of the substrate and a second, third, fourth, etc. laser-active coating formulations may be applied to second, third, fourth, etc. regions, respectively, of the substrate. Activation of the coatings may produce a graphic having a different appearance, e.g., a different color and/or different width in differing regions of the substrate. For example, the coatings of the respective regions may be formulated to have a common color prior to lazing, but to produce different colors from one another in lazed areas. Alternatively, the coatings of the respective regions may be formulated to have different colors from one another prior to lazing, but to produce a common color in areas that are lazed. In addition to being different colors, the different regions may include graphics having different widths or degrees of distinctness. For example, a first region may include a graphic comprising fine lines and intricate details and another region may include a graphic comprising hazy less distinct lines.

The examples that follow are intended to further illustrate, and not limit, embodiments in accordance with the invention. All percentages, ratios, parts, and amounts used and described herein are by weight unless indicated otherwise.

Unless otherwise specified, all references to percent or weight percent are based on dry weight percent, i.e., not including water.

### EXAMPLES

Coating formulations according to an embodiment of the invention were prepared by making a tint base and a plurality of pigment pastes separately. The pigment pastes were individually added into the tint base to make paints of multiple desired colors. The tint base contained the resin and sufficient amount of TiO₂ and fillers to ensure the desired color and hiding power, while the pigment paste contained the individual coloring material made of inorganic pigment dispersed in wetting agent and glycol.

To make the tint base, a high speed dispersion tank was initially filled with 30.00% water and 0.05% of bentonite clay. The solution was mixed at 300 rpm from 5 to 10 minutes until the solution became cloudy, indicating the rheologically active clay had swollen. Then, 0.05% antifoam and 0.1% dispersing agent additives were added. Next, 1.25% white TiO₂ and 1.66% yellowish TiO₂ (Hitox®) pigment were added. The yellowish Hitox® is a substitute TiO₂ that is less expensive than white TiO2. Hitox® provides opacity lower than the white TiO2 but it has higher opacity than other fillers. The TiO₂ was pre-dispersed for five minutes, and then the disperser speed was raised slowly from 300 to 1,000 rpm. The fillers were then added slowly. The fillers included 20% calcium carbonate, 1% kaolin, and 5% talc. The mixture continued to grind for 25 minutes or until the smallest grind particle obtained had sizes ranging from 2 to 2.5 mils Hegman fineness. A thick paste was produced at the end of the grinding process. After grinding, the disperser was slowed down to 300 rpm, then 2% coalescing solution of 2-ethoxy butoxy ethanol prepared in 75% solution in water, and 0.5% polyether urea polyurethane associative thickener, were added slowly. The resin component, about 40%, was added last in the grind mix.

The pigment paste was prepared according to individual color. Each color paste had the same percent weight composition of the components. To make a pigment paste, for example, of a yellow iron oxide, a pebble mill jar was filled with 23% of the pigment and 75.0% water. The rest were additives consisting of 0.12% bentonite organo clay, 0.12% antifoam, 1.0% dispersing agent, and 0.6% propylene glycol. The mill was set at 300 rpm, and grinding was performed for an hour. After grinding, the dispersed pigment was filtered and washed from the pebbles into a clean container. The dispersion was thickened with 3% hydroxyethyl cellulose (HEC) prepared in 1 to 1.5% solution in water. A few drops of biocides, about 0.06%, were added to prevent the dispersion from possible microbial attack. Besides the yellow iron oxide, other color dispersions prepared individually were red autumn oxide, red iron oxide, black, and brown.

To make the paint, the pigment paste or individual pigment pastes of different colors were combined into the tint based to achieve a desired color. The paint was mixed thoroughly before it was sprayed on a Masonite® interior door skin. The paint was dried for two days and then etched with a laser beam. For the purpose of laser study, two types of resin with different glass transition temperatures were substituted in the tint base. It was determined that the formulation including a resin having a T_{g} of 53° C. in the tint base resulted in an activated region having a path width that was approximately 11 microns wider than that produced with the same formulation including a resin having a T_{g} of 12° C.

It was also found that a formulation containing more than 70% fillers and heat resistant pigment or combination does not ablate as well. The high amount of fillers and pigment is sufficient to dissipate the heat generated by laser.

The methods and formulations of several embodiments described herein may be useful for effectively and efficiently producing graphics on substrates. Advantageously, by preparing laser-activated coating formulations wherein one or more properties of the formulation are controlled, the activation of the formulation and thus the formation of the graphic may be easily and effectively controlled. Additional advantages, as well as additional inventive features will be apparent from the description of the invention provided herein.

While this invention has been described with an emphasis upon certain embodiments, it will be obvious to those of ordinary skill in the art that variations of the embodiments may be used and that it is intended that the invention may be practiced otherwise than as specifically described herein. Accordingly, this invention includes all modifications encompassed within the scope of the invention as defined by the following claims.

What is claimed is:

1. A method of forming a graphic in a surface of an article, comprising:
applying a laser beam to a laser-active coating on a surface of an article to mark a graphic in the laser-active coating, the laser active coating comprising a polymer binder and a pigment.

2. The method of claim 1, further comprising:
applying a mixture to the surface of the article to form the laser-active coating, the mixture comprising the polymer binder and the pigment.

3. The method of claim 1, further comprising:
drying the laser-active coating on the surface of the article.

4. The method of claim 1, wherein applying the laser beam to the laser-active coating produces a physical or a chemical change to the polymer binder.

5. The method of claim 1, wherein applying the laser beam to the laser-active coating produces a physical or a chemical change to the pigment.

6. The method of claim 1, wherein applying the laser beam to the laser-active coating causes the laser-active coating to ablate and thereby mark the graphic.

7. The method of claim 1, wherein applying the laser beam to the laser-active coating causes a color change to the laser-active coating to mark the graphic.

8. The method of claim 1, wherein the polymer binder comprises at least one member selected from the group consisting of polymethyl methacrylate, polymethyl acrylate, polybutyl acrylate, polystyrene acrylic copolymers, polyvinyl acrylate (PVA), polyhydroxyethyl acrylate, polyvinyl acetate, polyurethane, epoxy, styrene, styrene modified copolymers, cellulosic resin, and alkyd resin.

9. The method of claim 1, wherein the polymer binder has a glass transition temperature from about 12° C. to about 53° C.

10. The method of claim 1, wherein the polymer binder comprises about 30 percent to about 45 percent of the laser-active coating by dry weight.

11. The method of claim 1, wherein the pigment comprises at least one member selected from the group consisting of iron oxides, titanium dioxide, chromium oxides, viridian pigments, cobalt compounds, cadmium compounds, magnesium ferrite, zinc iron chromite, manganese compounds, ultramarine, bismuth yellow, iron blue, cobalt yellow, tin oxide, and antimony oxide.

12. The method of claim 1, wherein the pigment comprises about 0.1 percent to about 20.0 percent of the laser-active coating by dry weight.

13. The method of claim 1, wherein the laser-active coating further comprises at least one additive comprising 0.01 percent to 40 percent laser-active coating by dry weight, and wherein the at least one additive is selected from the group consisting of a wetting agent, a dispersing agent, a thixotropic agent, a surface defect control agent, a foam-control agent, and a biocide.

14. The method of claim 1, wherein the laser-active coating has a thickness of about 0.5 mils to about 6.0 mils.

15. The method of claim 1, wherein:
the laser-active coating comprises a laser-markable coating region of a first thickness and a non laser-markable coating region of a second thickness.

16. The method of claim 1, wherein:
the laser-active coating comprises a laser-markable coating; and
a non laser-markable coating underlying the upper coating.

17. The method of claim 1, wherein the laser active coating comprises a first coating of a first composition on a first region of a substrate of the article and a second coating of a second composition on a second region of the substrate, the first and second compositions differing from one another.

18. The method of claim 17, wherein non-lazed areas of the first and second coating regions are identical in color to one another, and wherein lazed areas of the first and second coating regions are different in color from one another.

19. The method of claim 17, wherein non-lazed areas of the first and second coating regions are different in color from one another, and wherein lazed areas of the first and second coating regions are identical in color to one another.

20. A laser-active coating formulation for forming graphics on substrates using a laser comprising
a polymer binder having a glass transition temperature in a range from about 12° C. to about 53° C.; and
a pigment.

21. An article comprising:
a substrate; and
a laser-active coating on the substrate, the laser-active coating comprising
a polymer binder having a glass transition temperature in a range from about 12° C. to about 53° C.; and
a pigment.
